(19) United States
(12) Patent Application Publication
(10) Pub. No.: US 2006/0158091 A1
(43) Pub. Date: Jul. 20, 2006

(54) Fluorescent lamp assembly

(76) Inventor: Jack Jiang, Princeton Jct., NJ (US)

Correspondence Address: William R. Evans;Ladas & Parry, 26 West 61 Street, New York, NY, 10023, US

(21) Appl. No.: 11/039,642

(22) Filed: Jan. 20, 2005

(51) Int. Cl. H01J 63/04; H01J 1/62

(52) U.S. Cl. 313/485

(57) ABSTRACT

A fluorescent lamp assembly comprises a light-transmissive envelope having an inner surface, wherein the inner surface is coated with phosphor, a quantity of an ionizable material such as mercury, along with a filled gas such as Noble gas Ar, is filled and sealed inside said envelope, at least one electrical terminal is set at one end of said envelope, at least one base is made of material with low thermal conductivity, and at least one pin is set on said at least one base and connected to said at least one electrical terminal. In the sleeved lamp assembly, the thermal insulating base restricts heat transfer from the lamp to ambient air outside the lamp. For application at a low temperature, good thermal insulating can reduce the need of power consumption of the lamp, and make the lamp energy efficient.

### BACKGROUND OF THE INVENTION

1. Filed of the Invention

The present invention relates to an elongated fluorescent lamp with a base made of material with low thermal conductivity so that the light output of the fluorescent lamp assembly at low temperature is similar to or possibly even higher than that at room temperature.

2. Description of the Related Art

The light output of any fluorescent lamp using mercury as a lighting agent depends on the mercury vapor pressure inside the lamp. Optimum pressure for the maximum light output for most fluorescent lamps occurs when the coldest spot on the lamp envelope tube is about 100 degree F. Ambient temperature and wind draft conditions affect the lamp temperature. The fluorescent lamps produce much less light output at low ambient temperature than they do at room temperature. The common solution is to put a light transmitting sleeve made of plastic or glass over the light tube. The plastic sleeve for the lamp also provides a protective shield for retaining broken glass, phosphor and mercury should the fluorescent lamp envelope be broken.

There are numerous proposals for using fluorescent lamps at low temperature, e.g., U.S. Pat. Nos. 2,135,696, 2,363,109, 2,581,959, 3,358,167, 3,453,470, 3,602,759, 3,720,826, 4,916,352, 5,188,451, 5,173,637, 5,536,998, and 5,729,085.

A standard fluorescent for the sleeved lamp assembly has an elongated glass tube and a metal base at each end of glass tube, each metal base having a flange portion adjacent the glass tube. The sleeve tube that is preformed from a plastic material covers over the glass tube with its inner surface substantially uniformly spaced apart from the outer surface of the glass tube to form an air gap as thermal insulation. The sleeve tube is substantially coextensive with the full diameter portion of the glass tube lengthwise of the lamp and is fastened to the flange portions of the lamps.

Referring to FIG. 1, it shows a conventional sleeved fluorescent lamp assembly 100. The lamp assembly 100 comprises light-transmissive envelope 102, electrode 104, metal base 106, pins 108, sleeve 110, and space rings 112. The inner surface of light-transmissive envelope 102 is coated with phosphor (not shown) and, a quantity of an ionizable material such as mercury, along with a fill gas such as Noble gas Ar, is filled and sealed within the envelope 102. The metal base 106 is bonded to the envelope 102 by adhesive 114. Pins 108 are electrically connected to the electrode 104 so as to conduct electricity. The spacing rings 112 are placed between the envelope 102 and the sleeve 110 for maintaining proper air gap therebetween.

Although the sleeved assembly 100 using standard fluorescent lamp may be satisfactory for safety and prevention of scattering of glass fragments and other debris, they have been found to be quite unsatisfactory on light output and energy efficiency for applications at low temperature environment such as frozen food cabinets. One of the problems is that light output is too low. For example, the sleeved standard 40 W T12 or 32 W T8 fluorescent lamp at ambient temperature of −10 degree C. produces only about 15% of its light output at room temperature. In order to obtain more light output, lamp with higher output (HO) or even ultra high output (UHO) are sometimes chosen in the sleeved lamp assemble for the freezer applications. The 48″ 40 W T12 lamp has its high output version of 60 W and ultra light output of 110 W, both of which have the same overall length and diameter as its standard 40 W T12. Obviously, high power consumption is not a desired expense for this type of application in general.

The main factor causing the low light output is that the standard lamps use metal for the base material (aluminum base is most common) for elongated fluorescent lamp, and the end face of metal base in the assembly is exposed to the cold environment, resulting in the coldest temperature point of the lamp at the boundary of glass tube and the flange portion of metal base. Typically, metals such as aluminum have high thermal conductivity. As the coldest temperature of the lamp is below its optimum temperature due to heat dissipation through the metal base, the light output drops accordingly.

### SUMMARY OF THE INVENTION

An objective of the present invention is to provide a sleeved fluorescent lamp assembly, in which a base for the lamp is made of material with low thermal conductivity. With the low thermal conductive base, the fluorescent lamp assembly also has an air gap between the lamp and the sleeve, and the thermal insulating base and air restrict heat transfer from the lamp to ambient air outside the assembly. A good thermal insulating can reduce the need of power consumption of the lamps, and make the sleeved lamp assembly energy efficient.

### BRIEF DESCRIPTION OF THE DRAWINGS

FIG. 1 shows a conventional sleeved fluorescent lamp assembly;

FIG. 2 shows an embodiment of the sleeved fluorescent lamp of the present invention.

FIG. 3 shows test data providing comparison between the lamp of the present invention and that of the prior art.

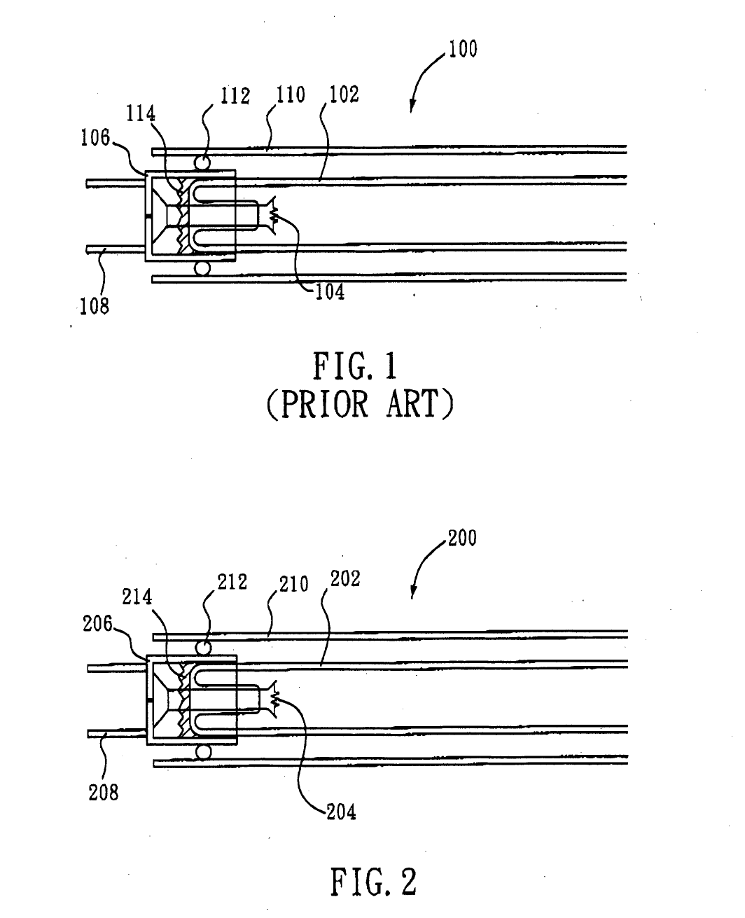

### DETAILED DESCRIPTION OF PREFERRED EMBODIMENTS

Referring to FIG. 2, it is an exemplary embodiment that shows a sleeved fluorescent lamp assembly 200 of the present invention. The assembly 200 comprises light-transmissive envelope 202, electrode 204, base 206, pins 208, spacing rings 212, and sleeve 210. The inner surface of the envelope 202 is coated with phosphor (not shown) and a quantity of an ionizable material such as mercury, along with a fill gas such as Noble gas Ar, is filled and sealed within the envelope 202. The base 206 is bonded to the envelope 202 by adhesive 214. Pins 208 are electrically connected to the electrode 204 so as to conduct electricity. Sleeve 210 is used to prevent the scattering of the envelope 202 and other debris when the envelope 202 breaks. The base 206 is made of material with low thermal conductivity at 0.003 W/cm ° C. or less. Table 1 shows thermal conductivity of various substances, wherein phenolic, rubber, epoxy resin, garolite, plastic, etc. can be used as the material formed of the base 206. The spacing rings 212 are placed between the envelope 202 and the sleeve 210 for maintaining proper air gap therebetween. The advantage of the present invention is that the base 206 made of material with low thermal conductivity can prevent heat from transferring from the envelope 202 to the ambient air. Since the heat is kept within the envelope 202, the temperature thereof can be maintained at a temperature above 100 degree F. to keep an optimum pressure for the maximum light output. Accordingly, the air gap and low thermal conductive base 206 can reduce heat loss to the cold ambient environment.

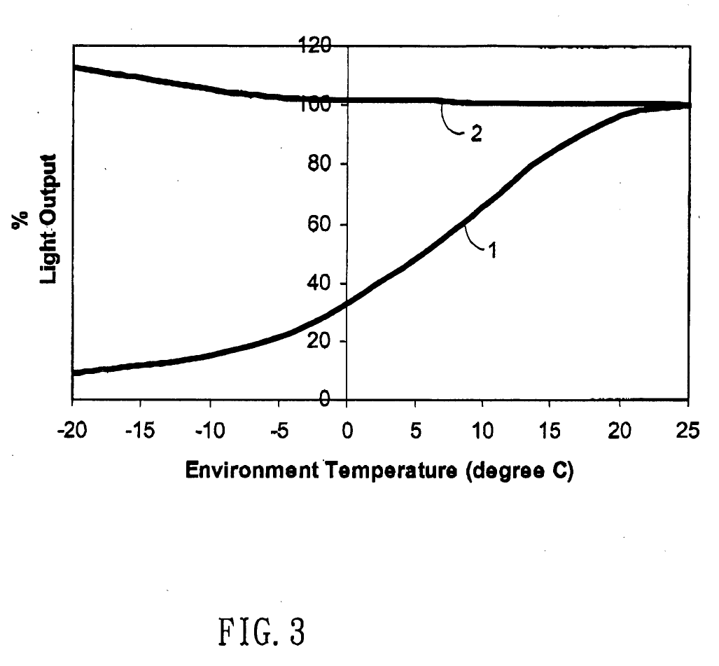

FIG. 3 shows test data providing comparison between a 24″ long sleeved fluorescent lamp assembly of the present invention and a 24″ long sleeved standard 17 W T8 of the prior art. The sleeve used for both lamps is made of polycarbonate, 1.25″ OD, and 0.01″ thick. The lamp used in the present invention is rated 18 W but with 17 mm OD on glass tube and plastic bipin base. Both lamps are tested at 0.24 amp lamp current provided by a standard electronic ballast for T8 and similar lamps. The light output is normalized with its light output at 25 degree C. Light output for conventional T8 (curve 1) reduces as temperature drops. However, the lamp assembly of the present invention basically maintains its light output (curve 2) as the temperature drops from 25 to 0 degree C. As temperature drops to −20 degree C., the lamp assembly of the present invention actually gains 10% light output compared with that at 25 degree C. However, the conventional sleeved T8 has merely about 10% light output.

The concept of this invention can also be applied to the elongated fluorescent lamp with other type of base, such as single pin base, and recess double contact base. In addition, the invention should apply to the fluorescent lamp assembly which incorporates different packaging methods or techniques, such as the coupling between the base and sleeve, (including use of adhesive), and sleeve with small venting holes which allows breath or release air between the lamp and sleeve when the lamp is heated.

TABLE 1

| | Thermal Conductivity |
|---|---|
| Substance | (W/cm ° C.) |
| Air (still) | 0.0003 |
| Alumina | 0.276 |
| Alumina (85%) | 0.118 |
| Aluminum | 2.165 |
| Beryllia (99.5%) | 1.969 |
| Beryllia (97%) | 1.575 |
| Beryllia (95%) | 1.161 |
| Beryllium | 1.772 |
| Beryllium-Copper | 1.063 |
| Boron Nitride | 0.394 |
| Brass (70/30) | 1.220 |
| Copper | 3.937 |
| Diamond (room temp) | 6.229 |
| Epoxy | 0.002 |
| Epoxy (thermally conductive) | 0.008 |
| FR-4 (G-10) | 0.003 |
| GaAs | 0.591 |
| Glass | 0.008 |
| Gold | 2.913 |
| Heatsink Compound | 0.004 |
| Helium (liquid) | 0.000307 |
| Iron | 0.669 |
| Lead | 0.343 |
| Magnesium | 1.575 |
| Mica | 0.007 |
| Molybdenum | 1.299 |
| Monel | 0.197 |
| Mylar | 0.002 |
| Nickel | 0.906 |
| Nitrogen (liquid) | 0.001411 |
| Phenolic | 0.002 |
| Platinum | 0.734 |
| Sapphire (a-axis) | 0.32 |
| Sapphire (c-axis) | 0.35 |
| Silicon (pure) | 1.457 |
| Silicon (0.0025 Ω-cm) | 1.457 |
| Silicon Carbide | 0.90 |
| Silicon Dioxide (amorphous) | 0.014 |
| Silicon Dioxide (quartz, a-axis) | 0.059 |
| Silicon Dioxide (quartz, c-axis) | 0.11 |
| Silicone Grease | 0.002 |
| Silicone Rubber | 0.002 |
| Silicon Nitride | 0.16-0.33 |
| Silver | 4.173 |
| Stainless Steel (321) | 0.146 |
| Stainless Steel (410) | 0.240 |
| Steel (low carbon) | 0.669 |
| Teflon | 0.002 |
| Tin | 0.630 |
| Titanium | 0.157 |
| Tungsten | 1.969 |
| Water | 0.0055 |
| Zinc | 1.024 |

Approximate values from 0° C. to 100° C.

What is claimed is:

1. A fluorescent lamp assembly comprising:
a light-transmissive envelope having an inner surface, the inner surface being coated with phosphor;
a quantity of an ionizable material being filled and sealed inside said envelope;
at least one electrical terminal set at one end of said envelope;
at least one base made of material with low thermal conductivity;
a sleeve providing a protective shield; and
an air gap being formed between said light-transmissive envelope and said sleeve for thermal insulation.

2. The fluorescent lamp assembly of claim 1, wherein said ionizable material is mercury.

3. The fluorescent lamp assembly of claim 1, further comprising a fill gas inside said envelope.

4. The fluorescent lamp assembly of claim 2, further comprising a fill gas inside said envelope.

5. The fluorescent lamp assembly of claim 3, wherein said filled gas is noble gas.

6. The fluorescent lamp assembly of claim 4, further comprising at least one pin being set on said at least one base and connected to said at least one electrical terminal.

7. The fluorescent lamp assembly of claim 1, wherein said at least one base is bonded to said light-transmissive envelope by adhesive.

8. The fluorescent lamp assembly of claim 1, wherein said low thermal conductivity is 0.003 W/cm ° C. or less.

9. The fluorescent lamp assembly of claim 1, wherein said material with low thermal conductivity is phenolic, rubber, epoxy, resin, garolite or plastic.

10. The fluorescent lamp assembly of claim 1, further comprising at least one space ring between said light-transmissive envelope and said sleeve.

11. The fluorescent lamp assembly of claim 1, wherein said sleeve is made of clear plastic or glass.

12. An illuminating assembly comprising:
a fluorescent lamp, including:
a light-transmissive envelope having an inner surface, wherein the inner surface is coated with phosphor;
a quantity of an ionizable material being filled and sealed inside said envelope;
at least one electrical terminal set at one end of said envelope;
at least one base made of material with low thermal conductivity; and
at least one pin being set on said at least one base and connected to said at least one electrical terminal;
a sleeve providing a protective shield for said fluorescent lamp; and
an air gap being formed between said light-transmissive glass envelope and said sleeve for thermal insulation.

13. The illuminating assembly of claim 11, further comprising at least one space ring between said light-transmissive envelope and said sleeve.

14. The illuminating assembly of claim 11, wherein said light-transmissive envelope is bonded to said sleeve.

15. The illuminating assembly of claim 11, wherein said at least one base is bonded to said light-transmissive envelope by adhesive.

16. The illuminating assembly of claim 11, wherein the fluorescent lamp further comprises a gas filled inside said envelope.

17. The illuminating assembly of claim 15, wherein said filled gas is noble gas.

18. The illuminating assembly of claim 11, wherein said low thermal conductivity is 0.003 W/cm ° C. or less.

19. The illuminating assembly of claim 11, wherein said material with low thermal conductivity is phenolic, rubber, epoxy, resin, garolite or plastic.

20. The illuminating assembly of claim 11, wherein said sleeve is made of clear plastic or glass.
